(19) United States
(12) Patent Application Publication
(10) Pub. No.: US 2025/0053784 A1
(43) Pub. Date: Feb. 13, 2025

(54) SYSTEM AND METHOD FOR GENERATING UNIFIED GOAL REPRESENTATIONS FOR CROSS TASK GENERALIZATION IN ROBOT NAVIGATION

(71) Applicant: Robert Bosch GmbH, Stuttgart (DE)

(72) Inventors: Jonathan FRANCIS, Pittsburgh, PA (US); Gyan TATIYA, Medford, MA (US); Luca BONDI, Pittsburgh, PA (US); Bingqing CHEN, Pittsburgh, PA (US); Pongtep ANGKITITRAKUL, Dublin, CA (US)

(21) Appl. No.: 18/232,206

(22) Filed: Aug. 9, 2023

(51) Int. Cl. G06N 3/0455; G06N 3/08

(52) U.S. Cl. CPC G06N 3/0455; G06N 3/08

(57) ABSTRACT

The systems and methods described herein may include one or more processors configured to receive a command from a user related to a subject; access a representation space associated with the command; receive a first dataset related to the command, a second dataset related to the subject, and a third dataset which includes subjects related to the command; update the representation space based on at least one of the first, second, and third dataset; generate a goal representation based on the representation space; receive, from a plurality of sensors, a sensor data of a current environment; generate a first and a second series of steps based on the goal representation and the current environment; annotate the sensor data based on performance of the first series of steps to generate an annotated senor data; and update the second series of steps based on the annotated sensor data.

### TECHNICAL FIELD

The present disclosure relates to image processing utilizing a machine learning model for navigation.

### BACKGROUND

Machine Learning (ML) has been used in a variety of critical applications, including autonomous driving, medical imaging, industrial fire detection, and credit scoring. Such applications need to be thoroughly evaluated before deployment in order to assess model capabilities and limitations. Unforeseen model mistakes may cause serious consequences in the real world: for example, a false sense of security in ML models may cause safety issues in driver assistance and industrial systems, misdiagnoses in medical analysis or treatment analysis, and biases against individuals and groups.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a general aspect, a computer-implemented method may include receiving, by a device, a command from a user related to a subject. Computer-implemented method may also include accessing a representation space associated with the command, where similar subjects and commands in the representation space are clustered together. Method may furthermore include receiving a first dataset related to the command, a second dataset related to the subject, and a third dataset which includes subjects related to the command. Method may in addition include updating the representation space based on at least one of the first dataset, the second dataset, and the third dataset. Method may moreover include generating, by a goal description machine learning model, a goal representation based on the representation space. Method may also include receiving, from a plurality of sensors, a sensor data of a current environment. Method may furthermore include generating a first series of steps and a second series of steps based on the goal representation and the current environment. Method may in addition include annotating, by a progress description machine learning model, the sensor data based on performance of the first series of steps to generate an annotated senor data. Method may moreover include updating, by a policy machine learning model, the second series of steps based on the annotated sensor data.

Other embodiments of this aspect include corresponding computer systems, apparatus, and computer programs recorded on one or more computer storage devices, each configured to perform the actions of the methods.

Implementations may include one or more of the following features. Computer-implemented method where updating the representation space includes the steps of: analyzing the first dataset and the second dataset in view of the goal representation to determine an inter-task score for at least one subject represented in the representation space that is associated with the subject of the command; regularizing the position of the at least one subject in the goal representation based on inter-task score. Computer-implemented method where updating the representation space includes the steps of: analyzing the third dataset in view of the goal representation to determine an intra-task score for at least one subject represented in the representation space that is not associated with the subject of the command; regularizing the position of the at least one subject in the goal representation based on intra-task score. Computer-implemented method where the first dataset may include goal related sensor data organized as a tuple, where each sensor data is positively associated with the command, where each tuple may include a subject related sensor data, an instruction related sensor data, and an audio related sensor data; where the second dataset may include goal related sensor data organized as a tuple, where one of the sensor data is negatively associated with the command; and where the third dataset may include goal related sensor data organized as a tuple, where the sensor data is either negatively or positively associated with the command. Computer-implemented method where the policy machine learning model is further trained based on the annotated sensor data. Computer-implemented method where training of the goal description machine learning model, progress description machine learning model, and the policy machine learning model is frozen. Computer-implemented method where training of the goal description machine learning model, progress description machine learning model, and the policy machine learning model are trained at a server, and operate locally at the device.

Implementations of the described techniques may include hardware, a method or process, or a computer tangible medium.

### BRIEF DESCRIPTION OF THE DRAWINGS

FIG. 1 shows a system for training a neural network.

FIG. 2 shows a computer-implemented method for training a neural network.

FIG. 3 illustrates an embodiment of a system workflow identifying data slices and attributes associated.

FIG. 4 illustrates an embodiment of a workflow model of an overall system.

FIG. 5 illustrates an example of a data slicing workflow.

FIG. 6 illustrates an embodiment of an interface with an ability to output attributes associated with various slices of an input data.

FIG. 7 illustrates an embodiment of a flow chart of an algorithm to estimate model optimization.

FIG. 8 depicts a schematic diagram of control system configured to control power tool, such as a power drill or driver, which has an at least partially autonomous mode.

FIG. 9 depicts a schematic diagram of control system configured to control automated personal assistant.

FIG. 10 depicts a schematic diagram of control system configured to control monitoring system.

FIG. 11 depicts a schematic diagram of control system configured to control imaging system, for example an MRI apparatus, x-ray imaging apparatus or ultrasonic apparatus.

FIG. 12 depicts a goal description network which may be used to encode a rich representation of the task that is being performed.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In this disclosure, the systems and methods described herein may leverage multimodal foundation models in a machine learning training and inference pipeline. The systems and methods described herein may be configured to use foundation models are models that have large capacities for data representation (e.g., through vast numbers of layer sizes and internal weight and bias parameters, as in Large Language Models or “LLMs”) that have been additionally pre-trained on multiple massive datasets. These datasets may consist of millions of paired-data samples (e.g., images with their captions) and the LLMs may be trained with one or more objectives. In some embodiments, the objective may be to learn to score the alignment (i.e., similarity) between the inputs, (e.g., an arbitrary image and an arbitrary text caption). Another objective may include reconstructing an image, given a natural language text caption and the corresponding image when random patches of the data are missing or deleted. Alongside these training objectives, some intermediate continuous-valued vector representations from the foundation model may be used to perform (i.e., pretext) tasks (e.g., image classification, image captioning, object segmentation, semantic segmentation, object recognition, or any other appropriate mathematical concept).

In some embodiments, the systems and methods described herein may be configured to use the foundation model to perform one of the tasks in its set of pretext tasks. Through this extensive pre-training (e.g., using large datasets with challenging training objectives, on various pretext tasks), the LLM may have amassed enough training in multiple domains to serve as a basis for task-specific architectures that may be built atop the foundation model. In some embodiments the systems and methods described herein may be configured to, after the pre-training of the foundation models, configure the foundation models so they may be non-trainable (i.e., frozen) and simply used in an “inference mode” on a variety of downstream tasks. In this manner, the foundation model may enable cross-domain generalization capabilities of the downstream task-specific framework, through the experience of modelling several tasks and domains.

In the context of robot navigation, for example, agents may implicitly perform goal-description (i.e., encoding a rich representation of the task that it needs to perform), progress representation learning and monitoring (i.e., examining the current information and comparing it with the goal, to inform action-selection), and multimodal alignment (i.e., learning the complementarity between different modalities or “views” that capture novel scenarios).

The systems and method described herein may be configured for the extraction, refinement, and use of versatile representations of task goals, derived in part from foundation models, in the context of multimodal goal-directed robot navigation. The systems and methods described herein may be configured to obtain the cross-domain generalization capability (preserved from the foundation model), together with competitive in-domain performance (from task-specific components).

The systems and methods described herein may be directed to goal-directed multimodal robot navigation which is a task within the artificial intelligence community. Several robot navigation task variants have a specific modality in which a goal is specified. In INSTRUCTIONGOALtasks, for example, goals are specified as natural language commands; in OBJECTGOAL tasks, goals are specified via RGB images of objects; in AUDIOGOALtasks, goals are specified via the sounds of objects that the agent needs to locate. In each task, the agent may be able to monitor the progress towards the goal, via some other progress modality-often a visual signal (RGB images, videos, LiDAR frames, RADAR frames, depth frames, etc.) or an explicit state-action trajectory.

The systems and methods described herein may contain functionality that is best communicated as an equation. The equation may let M^{G} and M^{P} denote sets of inputs from the goal and progress modalities, respectively. At each timestep t, the agent becomes aware of the state sₜ of the environment, which can be defined in terms of the goal and progress inputs up to the current timestep, such that sₜ={(m₀^{G}, m₀^{P}), (m₁^{G}, m₁^{P}), . . . , (mₜ^{G}, mₜ^{P})}, where mₜ^{G}∈M^{G} and mₜ^{P}∈M^{P}. At each timestep, the agent may execute an action aₜ∈A (from action space A), in order to transition the environment between physical states to the next state Sₜ₊₁. For the goal driven problem Φ_{GDN}, there exists an admissible solution ψ∈Ψ_{Φ}_{_{GDN}} which includes an initial state so to reach s_{goal}, i.e., ψ={s₀, a₀, s₁, a₁, . . . , a_{T}, s_{goal}}, for some episode length T. The agent's objective is to generate a predicted solution trajectory \hat{ψ} that closely aligns with a true admissible solution ψ.

The systems and methods described herein may be provide a novel framework for harnessing foundation models (e.g., CLIP) for generalization across multiple goal-directed robot navigation tasks. The differences across these tasks is the input modality used to specify the goal (e.g., natural language text in the case of INSTRUCTIONGOAL tasks, images in the case of OBJECTGOALtasks, acoustic signals in the case of AUDIOGOAL tasks, etc.). The systems and methods described herein may be configured to enable an agent to generalize across various goal-directed navigation tasks, the agent with a unified encoding algorithm (i.e., which may process any subset of the goal modalities, in the set of supported *-GOALtasks, into a semantically-consistent multimodal goal representation). The encoder may be obtained via a foundation model architecture; observing that the foundation model may not have all the input interfaces for the desired set of *-GOAL robot navigation tasks, the systems and methods described herein may be configured to generate datasets from robot simulation environments to ground the foundation model in the additional goal modalities. Once the systems and methods described herein obtain our grounded foundation model, which may support the appropriate set of input goal modalities, the systems and methods described herein train a goal decoder on top of the grounded foundation model. This goal decoder may serve to further align goal representations from the different modalities, while also contextualizing the goal representations for robot navigation tasks.

The systems and methods described herein may consist of a grounded foundation model, a goal decoder, progress encoder modules, policy encoder/decoder modules, and a policy network.

The systems and methods described herein may configured to ground a CLIP-like foundation model with an additional modality, e.g., audio, we leverage CLIP4X. CLIP4X is a general framework that we have developed, for grounding a new modality ‘X’ in CLIP or a CLIP-like foundation model (e.g., Align and LiT). This is done to avoid duplicate development effort in integrating a new modality ‘X’, such as audio for AudioGoal tasks, into an existing foundation model. This may also facilitate understanding of the relationship between modalities, including both existing modalities (i.e., image and natural language, and new modalities, such as audio, radar, and time series).

The systems and methods described herein may configured to utilize CLIP4X which implements functionalities that are envision and may be re-used by different projects (e.g., contrastive learning objectives, multi-GPU distributed training, commonly-used model components, a comprehensive suite of tests, and experiment logging). To make CLIP4X general and extensible, the code base is designed to be modular and configurable, leveraging the Hydra framework. To validate its use, the systems and methods described herein may use CLIP4X in several projects, where the X can be audio, radar, and time series. The users for CLIP4X may inherit classes from CLIP4X and add custom modules for a specific tasks.

Goal Decoder: Refining Goal Representation through Contrastive Regularization

A purpose of the goal decoder is to project the output of the grounded foundation model to a representation space that is usable by the downstream parts of the overall framework (e.g., the policy decoder). At the same time, we want the projected outputs of the grounded foundation model to already serve as generalizable and reusable goal representations for various Embodied AI tasks, in lieu of specific downstream navigation policy architectures.

In some embodiments, the systems and methods described herein may be configured so, regardless of the input goal modality used, samples from the same or different *-GOAL tasks should be “close” together in the goal decoder's latent space, as long as they are semantically similar (e.g., they refer to the same object, locations, tasks, actions, or any other concept related to the task). Conversely, semantically dissimilar samples should be well-separated in this space. For example, the goal decoder should ensure that goal descriptions in the form of an image of a telephone (i.e., as an ObjectGoal task objective, using the visual interface of the grounded foundation model), an instruction to ‘find the telephone’ (i.e., INSTRUCTIONGOAL, using the language interface), and the sound of a telephone ringing (i.e., AUDIOGOAL, using the newly-grounded audio interface) should all map to similar goal representations. The systems and methods described herein may be configured to call erty of representational versatility.

As a basis for representational versatility, the systems and methods described herein may be configured to construct three datasets. First, the systems and methods described herein construct a dataset Dinter+ with observations from the various *-GOAL tasks, wherein each sample consists of a goal observation tuple, strong internal semantic alignment (i.e., positive examples; “+”), as in the above telephone example, i.e., {Xᵢ^{OG}, Xⱼ^{IG}, Xₖ^{AG}}⁺∈ [symbol] , where the {“OG”, “IG”, “AG”} superscripts refer to the {OBJECTGOAL, INSTRUCTIONGOAL, AUDIOGOAL} tasks, respectively. Next, the systems and methods described herein construct a dataset Dinter−, wherein, for each sample of goal description observations {Xᵢ^{OG}, Xⱼ^{IG}, Xₖ^{AG}}⁻∈ [symbol] , there may exists at least one observation that is not semantically consistent with the other(s) (negative example; “−”). Finally, the systems and methods described herein may construct a third dataset Dintera, where each sample consists of a goal description observation pair from the same task, which may either be semantically-aligned (“+”) or semantically dissimilar (“−”), i.e.: {Xᵢ^{OG}, Xⱼ^{OG+}}∪{Xᵢ^{AG}, Xⱼ^{AG+}}∪{Xᵢ^{IG}, Xⱼ^{IG+}}∪{Xᵢ^{OG}, Xⱼ^{OG-}}∪{Xᵢ^{AG}, Xⱼ^{AG-}}∪{Xᵢ^{IG}, Xⱼ^{IG-}}∈Dᵢₙₜₑᵣₐ∀i,j∈{0, 1, 2, . . . , N}, i≠j, and a pre- determined number of dataset samples N. For the AUDIOGOAL task observations, the systems and methods described herein may use the dataset provided by Tatiya et al. (2022). For the INSTRUCTIONGOAL task observations, the systems and methods described herein start with the dataset provided by Ku et al. (2020), however, the systems and methods described herein may extract the last natural language sub-instruction from each sample, which provides a short textual description of the object/location that the agent needs to find/assume. For the OBJECTGOAL task observations, the systems and methods described herein may use the “OBJECTGOAL” task from Anderson et al., 2018, refined for the Habitat environment (Savva et al., 2019).

Equipped with these datasets, the systems and methods described herein may use the datasets to regularize the Goal Decoder representation to enforce representation versatility. The systems and methods described herein may do this by enforcing both intra-task contrast and inter-task contrast.

The systems and methods described herein may be configured to enforce intra-task contrast. Here, the systems and methods described herein may want to regularize the outputs of the Goal Decoder for similarity/contrast between samples from the same goal tasks. The systems and methods described herein may take random batch samples from [symbol] .

The systems and methods described herein may be configured to enforce inter-task contrast. Here, the systems and methods described herein may want to regularize the outputs of the Goal Decoder for similarity/contrast between samples from different goal tasks. The systems and methods described herein may take random batch samples from { [symbol] ∪ [symbol] }.

The systems and methods described herein may be configured to use grounded foundation models in goal-directed robot navigation. When grounding the foundation model with additional modalities, to support the new *-GOALtasks (e.g., audio for AUDIOGOAL), and when regularizing the extracted goal representations according to the intra- and inter-task contrastive objectives, the systems and methods described herein may be ready to begin using the grounded and regularized goal-description representations in downstream goal-direct navigation tasks. Goal inputs that express semantically similar tasks (as in the telephone example above) may be mapped to similar or identical goal representations. The systems and methods described herein may be configured to also want similar goal representations to be used to perform similar tasks. The systems and methods described herein may say that these goal representations are modality agnostic.

As further described below, the systems and methods described herein may utilize our goal representations from the “goal-description networks” to encode a rich representation of the task that needs to be performed, regardless of whether it is an AUDIOGOAL, OBJECTGOAL, or INSTRUCTIONGOAL task. Simultaneously, the systems and methods described herein may encode the progress modality (which happens to be visual context in all of the *-GOALrobot tasks), by way of the “Progress-monitoring Networks”. Both goal and progress representations may be fed to a downstream policy network. These component models could be implemented as trainable neural networks or any other types of models that have learnable/tunable internal functional parameters. The Goal-description networks may be kept frozen, after contrastive regularization, or may be further fine-tuned for additional task specialization. Progress and policy networks could be trained by way of imitation objectives, in the event expert demonstrations are provided, updated by way of a policy gradient-based objective _{lpg)}, or updated via any other manner that follows from how data and supervision are provided to the model(s).

The systems and methods described herein may be configured to include a task-specific agent component. Where module f_{enc} may be a visual encoder that maps observation to a visual vector representation space. Module f_{clf} may classify objects in the agent's visual context and implicitly combine visual representations with language embeddings of detected object labels as scene graph vertices. Those scene graph vertices may be fed into a graph-encoder network module GEN, in order to produce a spatial and semantics aware context representation. This GEN may facilitates the inclusion of scene priors-based pre-training and inference. Scene memory transformer M keeps track of prior contextual representations and automatically reprioritizes them for use by the “policy encoder”, which feeds outputs to a similar memory module Mₑ for the policy networks. Meanwhile, the goal embedding may be fed to the “policy decoder”, which implicitly, compares the context provided by Mₑ with the goal embedded—at each timestep. Which generates the appropriate state context vector to be used by the further downstream policy networks that perform action-value estimation and action-decoding.

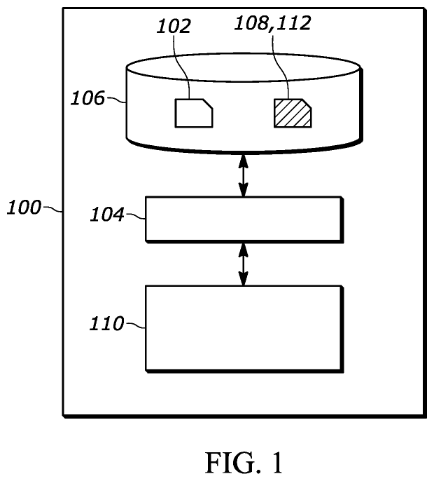

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

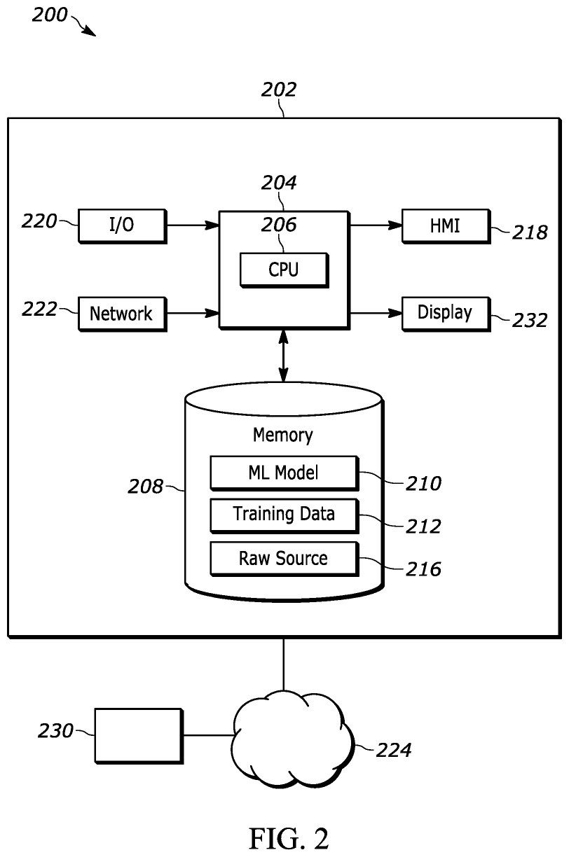

FIG. 2 depicts a computing system 200 to implement a system for annotating data. The computing system 200 may include at least one computing system 202. The computing system 202 may include processor 204 that is operatively connected to a memory unit 208. The processor 204 may include one or more integrated circuits that implement the functionality of a central processing unit (CPU) 206. The CPU 206 may be a processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning algorithm 210 or algorithm, a training dataset 212 for the machine-learning algorithm 210, raw source data 215.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 330 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the computing system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The computing system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The computing system 200 may implement a machine-learning algorithm 210 that is configured to analyze the raw source data 215. The raw source data 215 may include raw or unprocessed sensor data that may be representative of an input dataset for a machine-learning system. The raw source data 215 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 215. The raw source data 215 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 215 to identify the presence of the particular features. The machine-learning algorithm 210 may be configured to identify a feature in the raw source data 215 as a predetermined feature (e.g., pedestrian). The raw source data 215 may be derived from a variety of sources. For example, the raw source data 215 may be actual input data collected by a machine-learning system. The raw source data 215 may be machine generated for testing the system. As an example, the raw source data 215 may include raw video images from a camera.

In the example, the machine-learning algorithm 210 may process raw source data 215 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

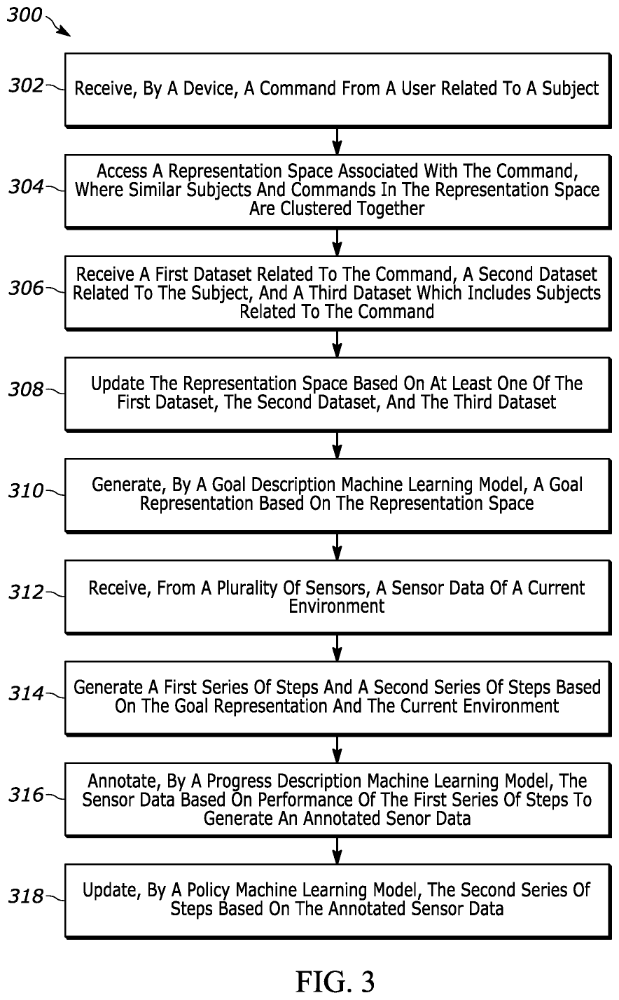

FIG. 3 is a flowchart of an example process 300. In some implementations, one or more process blocks of FIG. 3 may be performed by a machine-learning algorithm 210. In some implementation the process 300 may be performed by processor 204.

As shown in FIG. 3, process 300 may include receiving, by the device, a command from a user related to a subject (block 302). In some implantations the device may be computing system 200. For example, machine-learning network may receive, by a device, a command from a user related to a subject, such as a telephone. As also shown in FIG. 3, process 300 may include accessing a representation space associated with the command, where similar subjects and commands in the representation space are clustered together (block 304). For example, machine-learning network may access a representation space associated with a ringing phone, where similar devices, similar audio, and similar tasks related to those devices being clustered in the representation space in view of their similarity. In some implementations, the representation space is prepopulated with data objects representing subjects, tasks, and audio with the space between the data objects in the representation space indicating a level of similarity. For example, a smart phone and a flip phone would be closer together than a rotary phone.

As further shown in FIG. 3, process 300 may include receiving a first dataset related to the command, a second dataset related to the subject, and a third dataset which includes subjects related to the command (block 306). For example, the process 300 may receive a first dataset with observations from the various previously performed tasks, wherein each observation consists of a goal observation tuple, strong internal semantic alignment (i.e., positive examples). The process 300 may receive a second dataset, wherein for each sample of goal description observations there exists at least one observation that is not semantically consistent with the other(s) (i.e., negative example). The process 300 may receive a third dataset, wherein each sample consists of a goal description observation pair from the same task, which can either be semantically-aligned (i.e., positive example) or semantically dissimilar (i.e., negative example).

As also shown in FIG. 3, process 300 may include updating the representation space based on at least one of the first dataset, the second dataset, and the third dataset (block 308). For example, machine-learning network may update the representation space based on at least one of the first dataset, the second dataset, and the third dataset to enforce representation versatility. As further shown in FIG. 3, process 300 may include generating, by a goal description machine learning model, a goal representation based on the representation space (block 310). For example, machine-learning network may generate, by a goal description machine learning model, a goal representation based on the representation space, as described above.

As also shown in FIG. 3, process 300 may include receiving, from a plurality of sensors, a sensor data of a current environment (block 312). For example, such sensors may include, but are not limited to temperature sensor, proximity sensor, IR sensor, accelerometer, gyroscope, compass, light sensor, moisture sensor, ultrasonic sensor, alcohol sensor, humidity sensor, smoke sensor, gas sensor, heartbeat sensor, or any other appropriate senor. As further shown in FIG. 3, process 300 may include generating a first series of steps and a second series of steps based on the goal representation and the current environment (block 314). For example, machine-learning network may generate a first series of steps where the device moves toward the subject of the command based on the best prediction of the location of the subject. As also shown in FIG. 3, process 300 may include annotating, by a progress description machine learning model, the sensor data based on performance of the first series of steps to generate an annotated senor data (block 316). For example, machine-learning network may annotate, by a progress description machine learning model, the sensor data based on performance of the first series of steps to generate an annotated senor data, as the steps are being performed.

As further shown in FIG. 3, process 300 may include updating, by a policy machine learning model, the second series of steps based on the annotated sensor data (block 318). For example, machine-learning network may update, by a policy machine learning model, the second series of steps based on the annotated sensor data, as described above.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

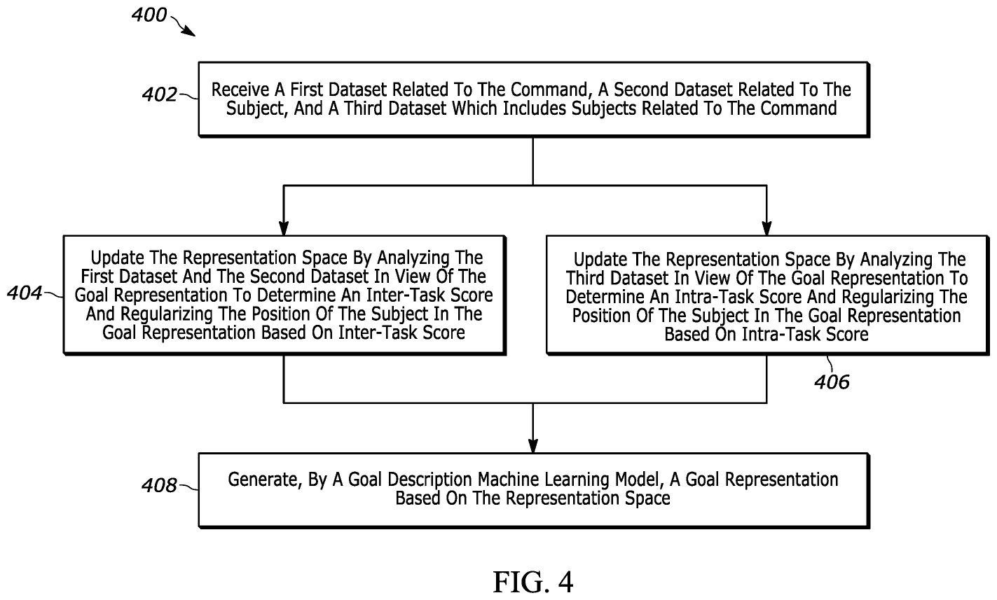

FIG. 4 is a flowchart of an example process 400 which focuses on the comparative and contrastive step when updating the representation space. In some implementations, one or more process blocks of FIG. 4 may be performed by a machine-learning network. In some implementation the process 400 may be performed by processor 204.

As further shown in FIG. 4, process 400 may include receiving a first dataset related to the command, a second dataset related to the subject, and a third dataset which includes subjects related to the command (block 402). For example, the process 400 may receive a first dataset with observations from the various previously performed tasks, wherein each observation consists of a goal observation tuple, strong internal semantic alignment (i.e., positive examples). The process 400 may receive a second dataset, wherein for each sample of goal description observations there exists at least one observation that is not semantically consistent with the other(s) (i.e., negative example). The process 400 may receive a third dataset, wherein each sample consists of a goal description observation pair from the same task, which can either be semantically-aligned (i.e., positive example) or semantically dissimilar (i.e., negative example).

Process 400 may include additional implementations, such as any single implementation or any combination of implementations described below and/or in connection with one or more other processes described elsewhere herein. As further shown in FIG. 4, process 400 may include updating the representation space which includes the steps of analyzing the first dataset and the second dataset in view of the goal representation to determine an inter-task score for at least one subject represented in the representation space that is associated with the subject of the command; regularizing the position of the at least one subject in the goal representation based on inter-task score (block 404). The process 400 may be configured to enforce intra-task contrast. For example, the process 400 may want to regularize the outputs of the Goal Decoder for similarity/contrast between samples from the same goal tasks.

As further shown in FIG. 4, process 400 may include updating the representation space which further includes the steps of analyzing the third dataset in view of the goal representation to determine an intra-task score for at least one subject represented in the representation space that is not associated with the subject of the command; regularizing the position of the at least one subject in the goal representation based on intra-task score (block 406). The process 400 may be configured to enforce inter-task contrast. For example, the process 400 may want to regularize the outputs of the Goal Decoder for similarity/contrast between samples from different goal tasks.

As further shown in FIG. 4, process 400 may include generating, by a goal description machine learning model, a goal representation based on the representation space (block 408). For example, machine-learning network may generate, by a goal description machine learning model, a goal representation based on the representation space, as described above.

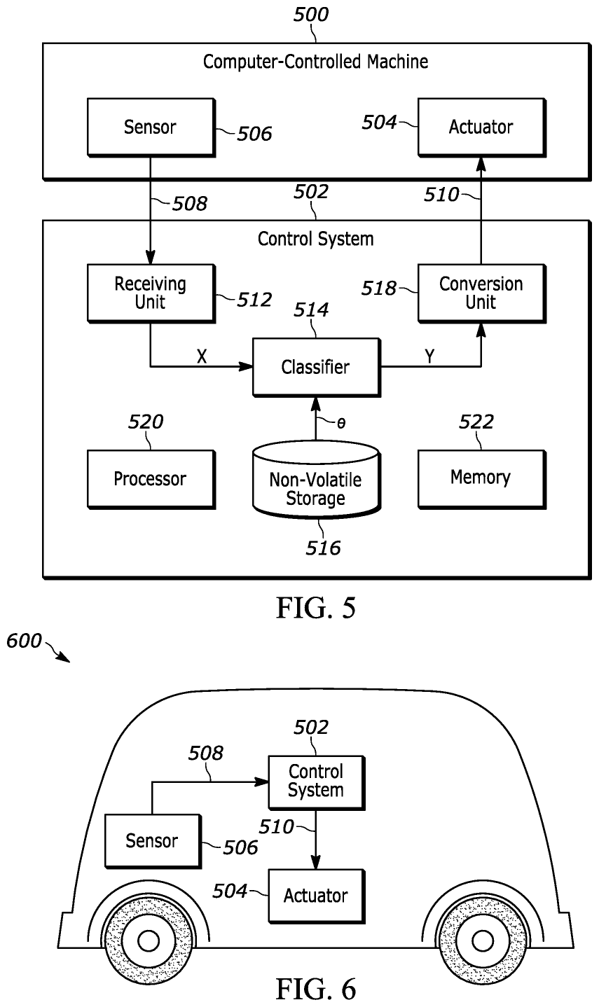

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to the computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause the control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

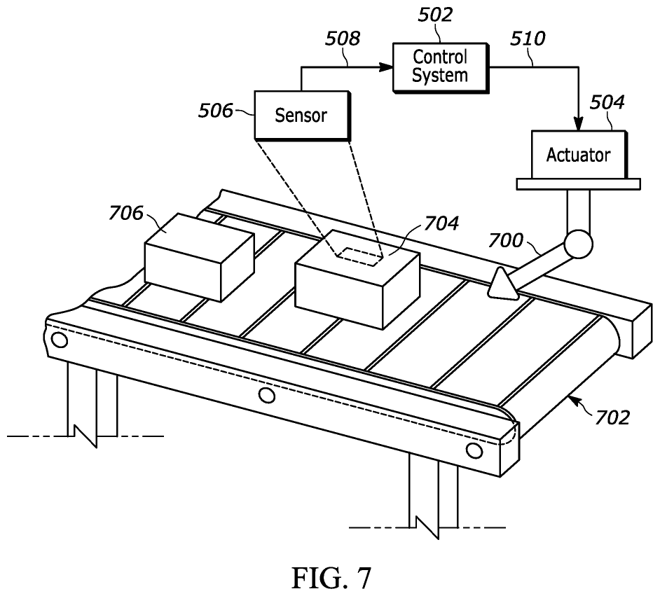

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of control system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of control system 700 (e.g., manufacturing machine) on subsequent manufactured product 706 of control system 700 (e.g., manufacturing machine) depending on the determined state of manufactured product 704.

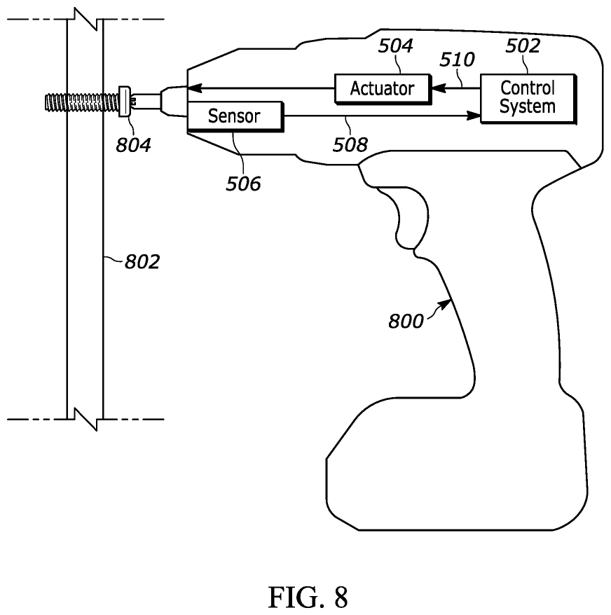

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of control power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of control power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

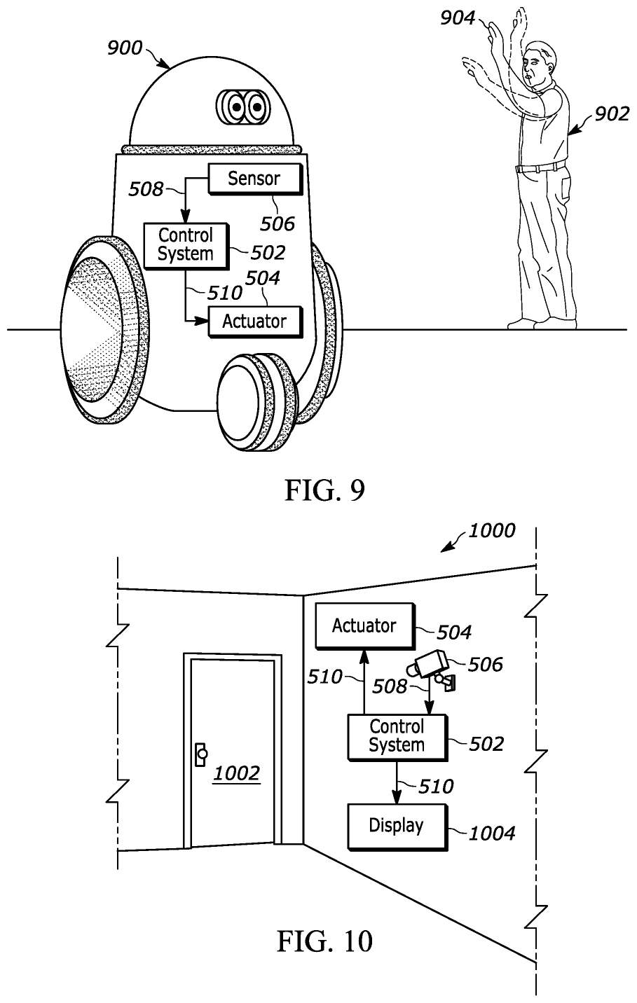

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

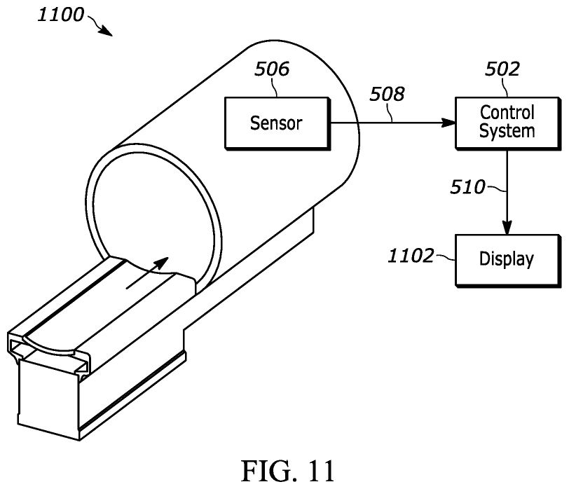

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

In some embodiments, a method for labeling audio data includes receiving, from at least one image capturing device, video stream data associated with a data capture environment. The method also includes receiving, from at least one audio capturing array, audio stream data that corresponds to at least a portion of the video stream data. The method also includes labeling, using output from at least a first machine-learning model configured to provide output including one or more object detection predictions, at least some objects of the video stream data. The method also includes calculating, based on at least one data capturing characteristic, at least one offset value for at least a portion of the audio stream data that corresponds to at least one labeled object of the video stream data and synchronizing, using at least the at least one offset value, at least a portion of the video stream data with the portion of the audio stream data that corresponds to the at least one labeled object of the video stream data. The method also includes labeling, using one or more labels of the labeled objects of the video stream data and the at least one offset value, at least the portion of the audio stream data that corresponds to the at least one labeled object of the video stream data. The method also includes generating training data using at least some of the labeled portion of the audio stream data and training a second machine-learning model using the training data.

In some embodiments, the at least one audio capturing array includes a plurality of audio capturing devices. In some embodiments, the at least one audio capturing array is remotely located from the at least one image capturing device. In some embodiments, labeling, using the output from at least the first machine-learning model, the at least some objects of the video stream data includes labeling the at least some objects of the video stream data with at least an event type, an event start indicator, and an event end indicator. In some embodiments, the at least one data capturing characteristic includes one or more characteristics of the at least one image capturing device. In some embodiments, the at least one data capturing characteristic includes one or more characteristics of the at least one audio capturing array. In some embodiments, the at least one data capturing characteristic includes one or more characteristics corresponding to a location of the at least one image capturing device relative to the at least one audio capturing array. In some embodiments, the at least one data capturing characteristic includes one or more characteristics corresponding to a movement of an object in the video stream data. In some embodiments, calculating, based on the at least one data capturing characteristic, the at least one offset value for the at least a portion of the audio stream data that corresponds to the at least one labeled object of the video stream data includes using at least one probabilistic-based function.

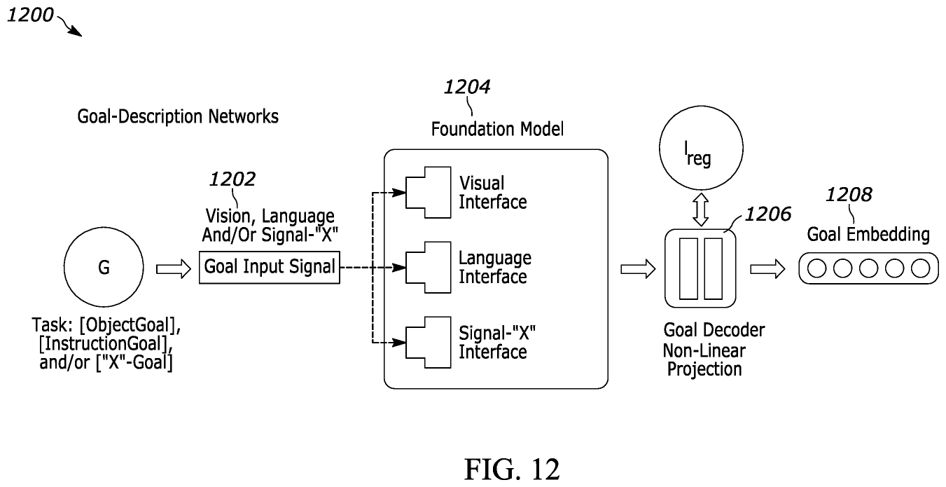

FIG. 12 depicts a goal description network 1200 which may be used to encode a rich representation of the task that is being performed. The goal description network 1200 leverages the grounded foundation model to extract a unified multimodal goal embedding and may executed by processor 204.

At 1202, the goal description network 1200 directs the goal input to the appropriate foundation model based on the modality of the goal input. For example, the goal input can be an image, a spoken command, a written command, or any appropriate modality. At 1204, the goal description network 1200 process each modality with its appropriate interface. For example, vision based commands will be routed to the visual interface, language based input signals are routed to the language interface, and audio based input goals are routed to the audio signal interface (a.k.a., signal “x” interface).

At 1206, the goal description network 1200 may route the output of the foundation model to the goal decoder which may refine the goal representation through contrastive regularization. For example, goal decoder may project the output of the grounded foundation model to a representation space that is usable by the downstream parts process described herein. At 1208, the goal description network 1200 generates updates or generates goal embedding based on the output of the goal decoder. The goal embedding includes all inputs related to the goal regardless of the modality of the input.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a machine-learning network, comprising:
receiving, by a device, a command from a user related to a subject;
accessing a representation space associated with the command, where similar subjects and commands in the representation space are clustered together;
receiving a first dataset related to the command, a second dataset related to the subject, and a third dataset which includes subjects related to the command;
updating the representation space based on at least one of the first dataset, the second dataset, and the third dataset;
generating, by a goal description machine learning model, a goal representation based on the representation space;
receiving, from a plurality of sensors, a sensor data of a current environment;
generating a first series of steps and a second series of steps based on the goal representation and the current environment;
annotating, by a progress description machine learning model, the sensor data based on performance of the first series of steps to generate an annotated senor data; and
updating, by a policy machine learning model, the second series of steps based on the annotated sensor data.

2. The computer-implemented method of claim 1, wherein updating the representation space includes the steps of:
analyzing the first dataset and the second dataset in view of the goal representation to determine an inter-task score for at least one subject represented in the representation space that is associated with the subject of the command; and
regularizing a position of the at least one subject in the goal representation based on inter-task score.

3. The computer-implemented method of claim 1, wherein updating the representation space includes the steps of:
analyzing the third dataset in view of the goal representation to determine an intra-task score for at least one subject represented in the representation space that is not associated with the subject of the command; and
regularizing a position of the at least one subject in the goal representation based on intra-task score.

4. The computer-implemented method of claim 1, wherein the first dataset comprises goal related sensor data organized as a tuple, wherein each sensor data is positively associated with the command, wherein each tuple comprises a subject related sensor data, an instruction related sensor data, and an audio related sensor data;
wherein the second dataset comprises goal related sensor data organized as a tuple, wherein one of the sensor data is negatively associated with the command; and
wherein the third dataset comprises goal related sensor data organized as a tuple, wherein the sensor data is either negatively or positively associated with the command.

5. The computer-implemented method of claim 1, wherein the policy machine learning model is further trained based on the annotated sensor data.

6. The computer-implemented method of claim 1, wherein training of the goal description machine learning model, progress description machine learning model, and the policy machine learning model is frozen.

7. The computer-implemented method of claim 1, wherein training of the goal description machine learning model, progress description machine learning model, and the policy machine learning model are trained at a server, and operate locally at the device.

8. A system for a machine-learning network comprising:
one or more processors configured to:
receive, by a device, a command from a user related to a subject;
access a representation space associated with the command, where similar subjects and commands in the representation space are clustered together;
receive a first dataset related to the command, a second dataset related to the subject, and a third dataset which includes subjects related to the command;
update the representation space based on at least one of the first dataset, the second dataset, and the third dataset;
generate, by a goal description machine learning model, a goal representation based on the representation space;
receive, from a plurality of sensors, a sensor data of a current environment;
generate a first series of steps and a second series of steps based on the goal representation and the current environment;
annotate, by a progress description machine learning model, the sensor data based on performance of the first series of steps to generate an annotated senor data; and
update, by a policy machine learning model, the second series of steps based on the annotated sensor data.

9. The system of claim 8, wherein updating the representation space includes the steps of:
analyzing the first dataset and the second dataset in view of the goal representation to determine an inter-task score for at least one subject represented in the representation space that is associated with the subject of the command
regularizing a position of the at least one subject in the goal representation based on inter-task score.

10. The system of claim 8, wherein updating the representation space includes the steps of:
analyzing the third dataset in view of the goal representation to determine an intra-task score for at least one subject represented in the representation space that is not associated with the subject of the command
regularizing a position of the at least one subject in the goal representation based on intra-task score.

11. The system of claim 8, wherein the first dataset comprises goal related sensor data organized as a tuple, wherein each sensor data is positively associated with the command, wherein each tuple comprises a subject related sensor data, an instruction related sensor data, and an audio related sensor data
wherein the second dataset comprises goal related sensor data organized as a tuple, wherein one of the sensor data is negatively associated with the command; and
wherein the third dataset comprises goal related sensor data organized as a tuple, wherein the sensor data is either negatively or positively associated with the command.

12. The system of claim 8, wherein the policy machine learning model is further trained based on the annotated sensor data.

13. The system of claim 8, wherein training of the goal description machine learning model, progress description machine learning model, and the policy machine learning model is frozen.

14. The system of claim 8, wherein training of the goal description machine learning model, progress description machine learning model, and the policy machine learning model are trained at a server, and operate locally at the device.

15. A machine-learning network for a machine-learning network comprising:
one or more processors configured to:
receive, by a device, a command from a user related to a subject;
access a representation space associated with the command, where similar subjects and commands in the representation space are clustered together;
receive a first dataset related to the command, a second dataset related to the subject, and a third dataset which includes subjects related to the command;
update the representation space based on at least one of the first dataset, the second dataset, and the third dataset;
generate, by a goal description machine learning model, a goal representation based on the representation space;
receive, from a plurality of sensors, a sensor data of a current environment;
generate a first series of steps and a second series of steps based on the goal representation and the current environment;
annotate, by a progress description machine learning model, the sensor data based on performance of the first series of steps to generate an annotated senor data; and
update, by a policy machine learning model, the second series of steps based on the annotated sensor data.

16. The machine-learning network of claim 15, wherein updating the representation space includes the steps of:
analyzing the first dataset and the second dataset in view of the goal representation to determine an inter-task score for at least one subject represented in the representation space that is associated with the subject of the command; and
regularizing a position of the at least one subject in the goal representation based on inter-task score.

17. The machine-learning network of claim 15, wherein the first dataset comprises goal related sensor data organized as a tuple, each sensor data is positively associated with the command, each tuple comprises a subject related sensor data, an instruction related sensor data, and an audio related sensor data;
wherein the second dataset comprises goal related sensor data organized as a tuple, wherein one of the sensor data is negatively associated with the command; and
wherein the third dataset comprises goal related sensor data organized as a tuple, wherein the sensor data is either negatively or positively associated with the command.

18. The machine-learning network of claim 15, wherein the policy machine learning model is further trained based on the annotated sensor data.

19. The machine-learning network of claim 15, wherein training of the goal description machine learning model, progress description machine learning model, and the policy machine learning model is frozen.

20. The machine-learning network of claim 15, wherein training of the goal description machine learning model, progress description machine learning model, and the policy machine learning model are trained at a server, and operate locally at the device.
